(19) United States
(12) Patent Application Publication
(10) Pub. No.: US 2013/0094265 A1
(43) Pub. Date: Apr. 18, 2013

(54) INTEGRATED INVERTER APPARATUS AND METHOD OF OPERATING THE SAME

(71) Applicants: Yuan-Fang LAI, Taoyuan County (TW); Ying-Sung CHANG, Taoyuan County (TW)

(72) Inventors: Yuan-Fang LAI, Taoyuan County (TW); Ying-Sung CHANG, Taoyuan County (TW)

(21) Appl. No.: 13/542,563

(22) Filed: Jul. 5, 2012

(30) Foreign Application Priority Data
Oct. 13, 2011 (TW) 100137069

(51) Int. Cl. H02M 7/537

(52) U.S. Cl. 363/131

(57) ABSTRACT

An integrated inverter apparatus and a method of operating the same are disclosed. The integrated inverter apparatus includes at least two inverter units and a control unit. The inverter units are electrically connected in parallel to each other. At least one of the inverter units has a plurality of field-effect transistor (FET) switches and at least another one of the inverter units has a plurality of insulated gate bipolar transistor (IBGT) switches. The control unit is electrically connected to the inverter units to control the transistor switches of the corresponding inverter units when an optimal efficiency of the integrated inverter apparatus is reached at different operation conditions of the inverter units.

### BACKGROUND OF THE INVENTION

1. Field of the Invention

The present invention relates generally to an inverter apparatus and a method of operating the same, and more particularly to an integrated inverter apparatus operating at an optimal efficiency and a method of operating the same.

2. Description of Prior Art

In general, insulated gate bipolar transistors (IGBTs) are usually used rather than metal-oxide-semiconductor field-effect transistor (MOSFETs) to as switches for a high-power inverter. The reason is that IGBTs have lower conductive losses compared with MOSFETs under the high current application. Also, the high-voltage MOSFET with a low on-resistance is unusual. In addition, a number of MOSFETs need to be connected in parallel to implement the same low conductive losses as that of the IGBTs. However, the costs of using the number of MOSFETs to implement low conductive losses are significant. In contrast, MOSFETs have lower switching losses, especially at a small load current because of a relative small drain-source voltage.

Reference is made to FIG. 1 which is a circuit diagram of a related art inverter apparatus with single inverter. A conventional three-level inverter is shown in FIG. 1 and a number of IGBT transistors are used as switches 102Aa˜102Ad for reducing conduction losses due to the high-current output operation. In particular, each switch 102Aa˜102Ad has an anti-parallel diode (not labeled), also known as a body diode, and a parasitic capacitance (not labeled) for providing a loop of releasing inductance energy when a zero voltage switching is operated. In order to reduce the switching losses of the IGBTs having poor switching performance, the switching frequency of the inverter is usually not too fast, typically is 18 kHz. However, the size and amount of inductors and capacitors cannot be completely minimized because of the lower switching frequency. Furthermore, a number of IGBTs need to be connected in parallel for the high-power application, resulting in the losses and temperature rise to increase design difficulty.

Reference is made to FIG. 2 which is a circuit diagram of a related art inverter apparatus with multi inverters. The topology with multi inverters has a first inverter 10A and a second inverter 20A and the first inverter 10A is electrically connected in parallel to the second inverter 20A in output terminals thereof. Hence, the first inverter 10A and the second inverter 20A distribute half of output power, respectively. The multi-inverter topology is usually provided to improve layout of heating elements, thus reducing the parallel amount of heating elements and overcoming unequal loss distribution. In addition, the output currents Ic1, Ic2 with 18-kHz switching frequency flowing through the output capacitors are equal to half of the ripple current so that the used components can be more elastic.

In addition, the first inverter 10A and the second inverter 20A can be operated by an interleaving control manner to separate the switch operation of the two inverters 10A, 20A. At this time, a frequency of the ripple current flowing through the capacitor is about double switching frequency, namely 36 kHz. Because of the reducing ripple current, the current flowing through the inductor is half of that under the un-interleaving control manner. Accordingly, the required amount of the output inductors and capacitors can be reduced. However, the used IGBTs have poorer switching speed and higher cross voltage than MOSFETs so that the efficiency of the inverter would be low under the light load operation.

Accordingly, it is desirable to provide an integrated inverter apparatus and a method of operating the same to provide IGBTs and MOSFETs as switch elements according to features and advantages thereof so that the integrated inverter apparatus is operated at the substantially optimal output efficiency.

### SUMMARY OF THE INVENTION

An object of the invention is to provide an integrated inverter apparatus to solve the above-mentioned problems.

The integrated inverter apparatus includes at least two inverter units and a control unit. The inverter units are electrically connected in parallel to each other. At least one of the inverter units has a plurality of field-effect transistor switches and at least another one of the inverter units has a plurality of insulated gate bipolar transistor switches. The control unit is electrically connected to the inverter units to control the transistor switches of the corresponding inverter units when an optimal output efficiency of the integrated inverter apparatus is reached at different operation conditions of the inverter units.

Another object of the invention is to provide a method of an integrated inverter apparatus to solve the above-mentioned problems.

The method includes the following steps: (a) At least two inverter units are provided; wherein at least one of the inverter units has a plurality of field-effect transistor switches and at least another one of the inverter units has a plurality of insulated gate bipolar, transistor switches. (b) A control unit is provided to obtain an optimal output efficiency of the integrated inverter apparatus reached at different operation conditions of the inverter units. (c) The transistor switches of the corresponding inverter units are controlled by the control unit when the integrated inverter apparatus is operated at the substantially optimal output efficiency.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit diagram of a related art inverter apparatus with single inverter;

FIG. 2 is a circuit diagram of a related art inverter apparatus with multi inverters;

FIG. 3A is a circuit block diagram of an integrated inverter apparatus operating at an optimal efficiency according to a first embodiment of the present invention;

FIG. 3B is a circuit block diagram of the integrated inverter apparatus operating at an optimal efficiency according to a second embodiment of the present invention;

FIG. 4 is a schematic curve chart of showing the output efficiency of the integrated inverter apparatus under different load conditions; and

FIG. 5 is a flowchart of a method of operating an integrated inverter apparatus operating at an optimal efficiency.

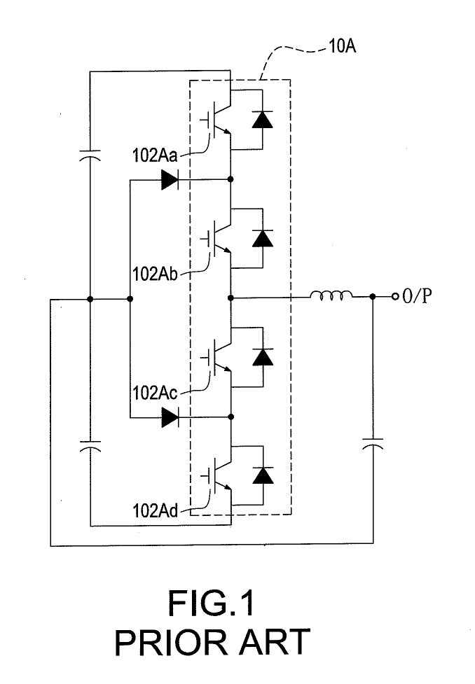

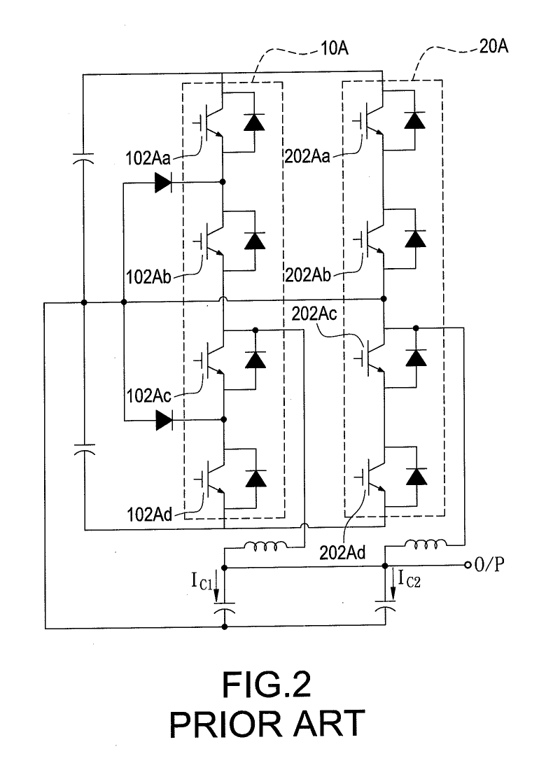

### DETAILED DESCRIPTION OF THE INVENTION

Reference will now be made to the drawing figures to describe the present invention in detail.

The present invention relates to an integrated inverter apparatus operating at an optimal efficiency. The integrated inverter apparatus operating at an optimal efficiency includes at least two inverter units and a control unit. The inverter units are electrically connected in parallel to each other. At least one of the inverter units has a plurality of field-effect transistor (FET) switches and at least another one of the inverter units has a plurality of insulated gate bipolar transistor (IBGT) switches. The control unit is electrically connected to the inverter units to control the transistor switches of the corresponding inverter units when an optimal output efficiency of the integrated inverter apparatus is reached at different operation conditions, such as an individual operation, an integral operation, or a combinational operation of the inverter units.

For convenience, in this embodiment, two inverter units are exemplified for further demonstration. That is, the integrated inverter apparatus includes a first inverter unit 10, a second inverter unit 20, and a control unit 30. The first inverter unit 10 is electrically connected in parallel to the second inverter unit 20. The first inverter unit 10 has four IGBT switches 102a˜102d. The second inverter unit 20 has four FET switches 202a˜202d. Note that, the FET switches 202a˜202d can be JFET switches or MOSFET switches. In this embodiment, the FET switches 202a˜202d are MOSFET switches, which are exemplified for further demonstration. The control unit 30 is electrically connected to the first inverter unit 10 and the second inverter unit 20 to produce a plurality of control signals S1˜S8 so as to control the IGBT switches 102a˜102d and the MOSFET switches 202a˜202d, respectively.

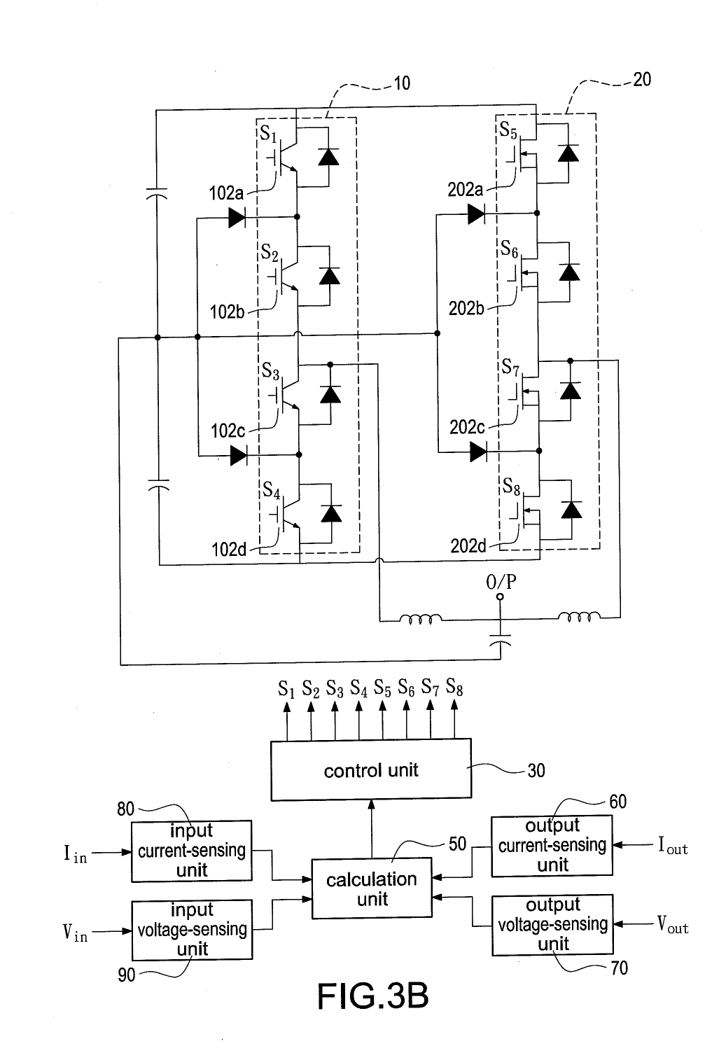

Reference is made to FIG. 4 which is a schematic curve chart of showing the output efficiency of the integrated inverter apparatus under different load condition. Note that, FIG. 4 is provided to indicate that the integrated inverter apparatus how to operate at the substantially optimal efficiency. As shown in FIG. 4, the abscissa represents variation of the load conditions and the ordinate represents the output efficiency of the integrated inverter apparatus. There are four curves—a first curve C1, a second curve C2, a third curve C3, and an optimal-efficiency curve Cm shown in FIG. 4. Note that, the first curve C1 indicates the output efficiency of the integrated inverter apparatus under different load conditions when only the first inverter unit 10 is operated, namely, only the IGBT switches 102a˜102d are controlled. Similarly, the second curve C2 indicates the output efficiency of the integrated inverter apparatus under different load conditions when only the second inverter unit 20 is operated, namely, only the MOSFET switches 202a˜202d are controlled. In addition, the third curve C3 indicates the output efficiency of the integrated inverter apparatus under different load conditions when both the first inverter unit 10 and the second inverter unit 20 are operated, namely, both the IGBT switches 102a˜102d and the MOSFET switches 202a˜202d are controlled.

As shown in FIG. 4, the optimal output efficiency is produced under the MOSFET switches 202a˜202d of the second inverter unit 20 are only controlled when the integrated inverter apparatus is operated at a light load. On the other hand, the output efficiency is not optimal under the MOSFET switches 202a˜202d of the second inverter unit 20 are only controlled when the integrated inverter apparatus is operated at a heavy load. In addition, the output efficiency of the integrated inverter apparatus under the IGBT switches 102a˜102d of the first inverter unit 10 are only controlled is less than that under the IGBT switches 102a˜102d of the first inverter unit 10 and the MOSFET switches 202a˜202d of the second inverter unit 20 are integrally controlled. That is, the substantially optimal output efficiency of the integrated inverter apparatus is produced under the IGBT switches 102a˜102d and the MOSFET switches 202a˜204d are integrally controlled. Accordingly, the output efficiency of the integrated inverter apparatus can be obtained by the control unit 30 at different operation conditions, such as the individual operation (at least two inverter units are required), the integral operation (at least two inverter units are required), or the combinational operation (at least three inverter units are required) of the inverter units when the integrated inverter apparatus is operated at different load conditions. Note that, the individual operation, the integral operation, and the combinational operation of the inverter units are exemplified for further description as follows:

1. The individual operation—We assume that the inverter units are a first inverter unit and a second inverter unit, respectively; the control unit controls the transistor switches (such as IGBTs or MOSFETs) of the first inverter unit when the optimal output efficiency of the integrated inverter apparatus is reached at an individual operation of the first inverter unit; the control unit controls the transistor switches (such as IGBTs or MOSFETs) of the second inverter unit when the optimal output efficiency of the integrated inverter apparatus is reached at an individual operation of the second inverter unit.

2. The integral operation—We assume that the inverter units are a first inverter unit and a second inverter unit; the control unit controls the transistor switches of the first inverter unit and the second inverter unit when the optimal output efficiency of the integrated inverter apparatus is reached at an integral operation of the first inverter unit and the second inverter unit.

3. The combinational operation—We assume that the inverter units are a first inverter unit, a second inverter unit, and a third inverter unit; the control unit controls the transistor switches of the first inverter unit and the second inverter unit when the optimal output efficiency of the integrated inverter apparatus is reached at a combinational operation of the first inverter unit and the second inverter unit; the control unit controls the transistor switches of the second inverter unit and the third inverter unit when the optimal output efficiency of the integrated inverter apparatus is reached at a combinational operation of the second inverter unit and the third inverter unit; the control unit controls the transistor switches of the first inverter unit and the third inverter unit when the optimal output efficiency of the integrated inverter apparatus is reached at a combinational operation of the first inverter unit and the third inverter unit.

At different load conditions, accordingly, the output efficiency of the integrated inverter apparatus is shown as the optimal-efficiency curve Cm.

For example, the optimal output efficiency of the integrated inverter apparatus is reached at the individual operation of the second inverter unit 20 when the load is 10% to 40%, that is the second curve C2 behaves the optimal-efficiency curve Cm. In addition, the optimal output efficiency of the integrated inverter apparatus is reached at the individual operation of the first inverter unit 10 when the load is 50%, that is the first curve C1 behaves the optimal-efficiency curve Cm. Furthermore, the optimal output efficiency of the integrated inverter apparatus is reached at the integral operation of the first inverter unit 10 and the second inverter unit 20 when the load is 60%˜100%, that is the third curve C3 behaves the optimal-efficiency curve Cm.

Thereinafter, one embodiment is exemplified for further demonstration. We assume that the integrated inverter apparatus is composed of the first inverter unit 10 with the IGBT switches and the second inverter unit 20 with the MOSFET switches, which have faster switching speed than IGBT switches. Also, the operation time of the inverters is controlled based on the load level conditions so that the integrated inverter apparatus is operated at the optimal efficiency under all load level conditions. The first inverter unit 10 is disabled and the second inverter unit 20 is enabled when the load is operated under a load level. Because the MOSFETs of the second inverter unit 20 have better switching performance, the conversion efficiency of the integrated inverter apparatus can be increased under the light load operation. When the load is operated under a heavier load level, the first inverter unit 10 is enabled so that the first inverter unit 10 and the second inverter unit 20 are operated by the interleaving control manner. At this time, the conversion efficiency of the integrated inverter apparatus can be increased because the IGBTs of the first inverter unit 10 have lower conductive losses, thus reducing the amount of the switching elements and costs.

Note that, the out of phase between the output voltage and the output current could occur because of different load types when the MOSFETs are provided to as switching elements of the inverter apparatus. Hence, the body diode inside the MOSFET would flow through the current. In general, the body diode inside the MOSFET has poor recovery performance to cause significant switching losses and reduce switching efficiency. Accordingly, the MOSFET with a fast recovery diode is provided to reduce switching losses thereof. More particularly, the operation time of the first inverter unit 10 and the second inverter unit 20 are controlled based on the load level conditions and different load types so that the integrated inverter apparatus can be operated at the optimal output efficiency based on the output load current with different power factors and crest factors.

Accordingly, the integrated inverter apparatus is composed of the first inverter unit 10 with the IGBT switches and the second inverter unit 20 with the MOSFET switches according to the features and advantages of the IGBTs and the MOSFETs. The inverter units 10, 20 are controlled at different operation conditions, such as an individual operation, an integral operation, or a combinational operation according to the variation of the load condition so that the integrated inverter apparatus is operated at the substantially optimal output efficiency.

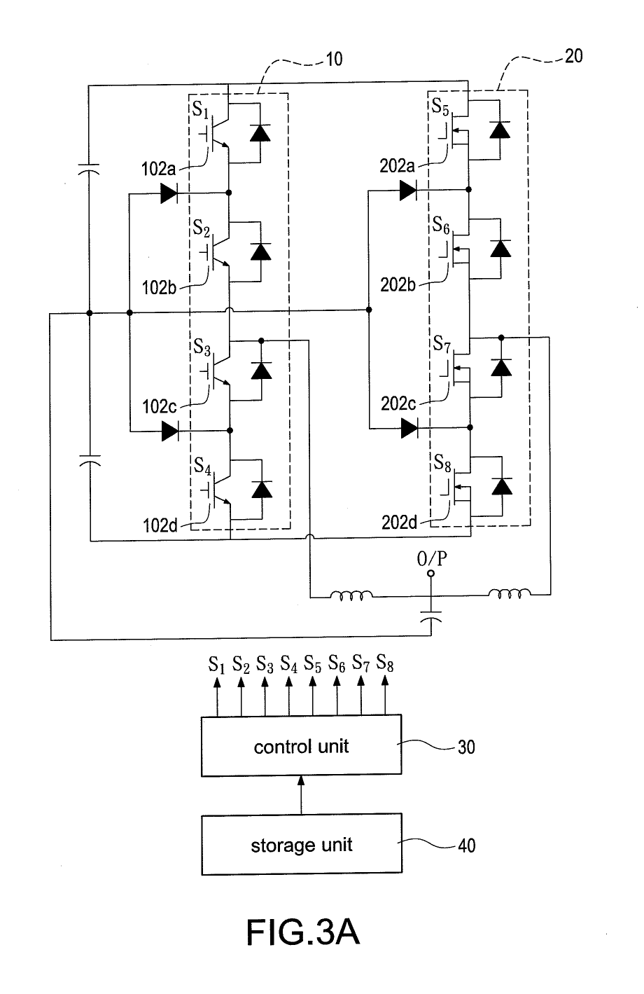

Especially to deserve to be mentioned, the curve chart as shown in FIG. 4 can be built in a way of a lookup table. Reference is made to FIG. 3A which is a circuit block diagram of an integrated inverter apparatus operating at an optimal efficiency according to a first embodiment of the present invention. In this embodiment, a storage unit 40 is provided to store the output efficiency of the integrated inverter apparatus operated at different operation conditions of the inverter units. Hence, the non-real-time lookup table manner can fast control the first inverter unit 10 and the second inverter unit 20 of the integrated inverter apparatus to reach the optimal output efficiency under different varied load conditions.

Furthermore, the integrated inverter apparatus can be operated at the optimal output efficiency by a real-time calculation process. Reference is made to FIG. 3B which is a circuit block diagram of the integrated inverter apparatus operating at an optimal efficiency according to a second embodiment of the present invention. The integrated inverter apparatus includes an output current-sensing unit 60, an output voltage-sensing unit 70, an input current-sensing unit 80, an input voltage-sensing unit 90, and a calculation unit 50. The output current-sensing unit 60 is electrically connected to an output side of the integrated inverter apparatus to sense a magnitude of an output current Iout of the integrated inverter apparatus. The output voltage-sensing unit 70 is electrically connected to the output side of the integrated inverter apparatus to sense a magnitude of an output voltage Vout of the integrated inverter apparatus. The input current-sensing unit 80 is electrically connected to an input side of the integrated inverter apparatus to sense a magnitude of an input current Iin of the integrated inverter apparatus. The input voltage-sensing unit 90 is electrically connected to the input side of the integrated inverter apparatus to sense a magnitude of an input voltage Vin of the integrated inverter apparatus. The calculation unit 50 is electrically connected to the output current-sensing unit 60, the output voltage-sensing unit 70, the input current-sensing unit 80, and the input voltage-sensing unit 90 to receive the sensed output current Tout, output voltage Vout, input current Iin, and input voltage Vin, respectively, and calculate the output efficiency of the integrated inverter apparatus when the inverter units operate at different conditions. The output efficiency of the integrated inverter apparatus is equal to a ratio between an output power and an input power. The output power is equal to a product of the output current Iout and the output voltage Vout and the input power is equal to a product of the input current Iin and the input voltage Vin. Hence, the real-time calculation manner can dynamically control the first inverter unit 10 and the second inverter unit 20 of the integrated inverter apparatus to reach the optimal output efficiency without calculation processes under different load conditions.

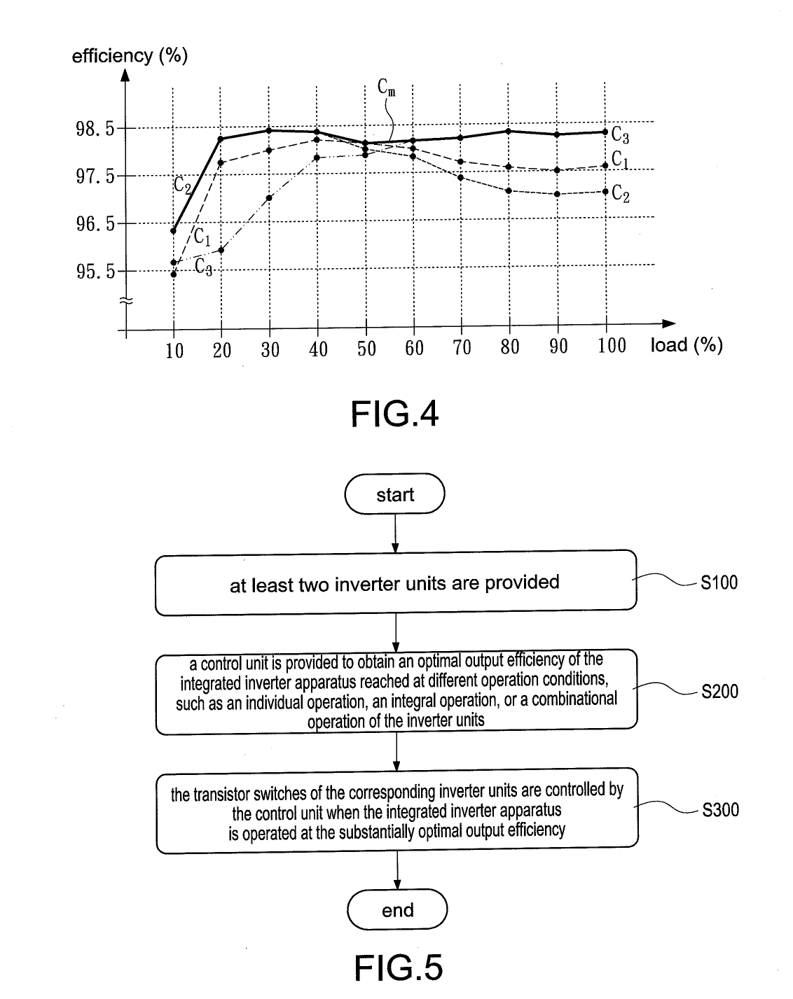

Reference is made to FIG. 5 which is a flowchart of a method of operating an integrated inverter apparatus operating at an optimal efficiency. The method includes the following steps: At least two inverter units are provided (S100); wherein at least one of the inverter units has a plurality of field-effect transistor (FET) switches and at least another one of the inverter units has a plurality of insulated gate bipolar transistor (IBGT) switches. Note that, the FET switches can be JFET switches or MOSFET switches. Also, each of the FET switches has a fast recovery diode therein to reduce switching losses of the field-effect transistor switches. A control unit is provided to obtain an optimal output efficiency of the integrated inverter apparatus reached at different operation conditions, such as an individual operation, an integral operation, or a combinational operation of the inverter units (S200). The transistor switches of the corresponding inverter units are controlled by the control unit when the integrated inverter apparatus is operated at the substantially optimal output efficiency (S300). In particular, the output efficiency of the integrated inverter apparatus is equal to a ratio between an output power and an input power. The output power and the input power can be calculated by a calculation unit according to an output current, an output voltage, an input current, and an input voltage. Also, the output current, the output voltage, the input current, and the input voltage are sensed by an output current-sensing unit, an output voltage-sensing unit, an input current-sensing unit, and an input voltage-sensing, respectively. Hence, the real-time calculation manner can dynamically control the first inverter unit and the second inverter unit of the integrated inverter apparatus to reach the optimal output efficiency under different varied load conditions. Furthermore, a storage unit is provided to store the output efficiency of the integrated inverter apparatus operated at different operation conditions of the inverter units. Hence, the non-real-time lookup table manner can fast control the first inverter unit and the second inverter unit of the integrated inverter apparatus to reach the optimal output efficiency under different varied load conditions.

In conclusion, the present invention has following advantages:

1. The IGBT switches and the MOSFET switches are integrated to implement an optimal operation between costs and efficiency of the integrated inverter apparatus. That is, the integrated inverter apparatus has lower costs and higher efficiency compared with an inverter apparatus with all MOSFET switches and with all IGBT switches, respectively.

2. According to the better switching performance of the MOSFETs, the MOSFETs are used to as the switches of the inverter unit to increase switching frequency up to N*18 kHz (in this embodiment) compared with the IGBTs so that the inverter units are operated by the interleaving control manner; and

3. The interleaving control manner is adapted to reduce the ripple current and the amount of the output inductors and capacitors, thus reducing costs and increasing power density.

Although the present invention has been described with reference to the preferred embodiment thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An integrated inverter apparatus comprising:
at least two inverter units, the inverter units electrically connected in parallel to each other; at least one of the inverter units having a plurality of field-effect transistor switches and at least another one of the inverter units having a plurality of insulated gate bipolar transistor switches; and
a control unit electrically connected to the inverter units to control the transistor switches of the corresponding inverter units when an optimal output efficiency of the integrated inverter apparatus is reached at different operation conditions of the inverter units.

2. The integrated inverter apparatus of claim 1, wherein the inverter units are a first inverter unit and a second inverter unit; the control unit controls the transistor switches of the first inverter unit when the optimal output efficiency of the integrated inverter apparatus is reached at an individual operation of the first inverter unit; the control unit is configured to control the transistor switches of the second inverter unit when the optimal output efficiency of the integrated inverter apparatus is reached at an individual operation of the second inverter unit.

3. The integrated inverter apparatus of claim 1, wherein the inverter units comprise a first inverter unit and a second inverter unit; the control unit is configured to control the transistor switches of the first inverter unit and the second inverter unit when the optimal output efficiency of the integrated inverter apparatus is reached at an integral operation of the first inverter unit and the second inverter unit.

4. The integrated inverter apparatus of claim 1, wherein the inverter units comprise a first inverter unit, a second inverter unit, and a third inverter unit; the control unit is configured to control the transistor switches of the first inverter unit and the second inverter unit when the optimal output efficiency of the integrated inverter apparatus is reached at a combinational operation of the first inverter unit and the second inverter unit; the control unit is configured to control the transistor switches of the second inverter unit and the third inverter unit when the optimal output efficiency of the integrated inverter apparatus is reached at a combinational operation of the second inverter unit and the third inverter unit; the control unit is configured to control the transistor switches of the first inverter unit and the third inverter unit when the optimal output efficiency of the integrated inverter apparatus is reached at a combinational operation of the first inverter unit and the third inverter unit.

5. The integrated inverter apparatus of claim 1, wherein switching frequency of the inverter unit with the field-effect transistor switches is integer times of switching frequency of the inverter unit with the insulated gate bipolar transistor switches to provide an interleaving control.

6. The integrated inverter apparatus of claim 1, wherein the field-effect transistor switches are junction field-effect transistor switches or metal-oxide-semiconductor field-effect transistor switches.

7. The integrated inverter apparatus of claim 1, wherein the integrated inverter apparatus further comprising:
an output current-sensing unit is electrically connected to an output side of the integrated inverter apparatus to sense a magnitude of an output current of the integrated inverter apparatus;
an output voltage-sensing unit is electrically connected to the output side of the integrated inverter apparatus to sense a magnitude of an output voltage of the integrated inverter apparatus;
an input current-sensing unit is electrically connected to an input side of the integrated inverter apparatus to sense a magnitude of an input current of the integrated inverter apparatus;
an input voltage-sensing unit is electrically connected to the input side of the integrated inverter apparatus to sense a magnitude of an input voltage of the integrated inverter apparatus; and
a calculation unit is electrically connected to the output current-sensing unit, the output voltage-sensing unit, the input current-sensing unit, and the input voltage-sensing unit to receive the sensed output current, output voltage, input current, and input voltage, respectively, and calculate the output efficiency of the integrated inverter apparatus when the inverter units operate at different conditions.

8. The integrated inverter apparatus of claim 7, wherein the output efficiency is equal to a ratio between an output power and an input power; the output power is equal to a product of the output current and the output voltage; the input power is equal to a product of the input current and the input voltage.

9. The integrated inverter apparatus of claim 1, wherein the integrated inverter apparatus further comprising:
a storage unit stores the output efficiency of the integrated inverter apparatus in a way of lookup table when the inverter units operate at different conditions.

10. The integrated inverter apparatus of claim 1, wherein each of the field-effect transistor switches has a fast recovery diode therein to reduce switching losses of the field-effect transistor switches.

11. A method of operating an integrated inverter apparatus, the method comprising:
(a) providing at least two inverter units; wherein at least one of the inverter units having a plurality of field-effect transistor switches and at least another one of the inverter units having a plurality of insulated gate bipolar transistor switches;
(b) providing a control unit to obtain an optimal output efficiency of the integrated inverter apparatus reached at different operation conditions of the inverter units; and
(c) controlling the transistor switches of the corresponding inverter units by the control unit when the integrated inverter apparatus is operated at the substantially optimal output efficiency.

12. The method of operating the integrated inverter apparatus of claim 11, in the step (c) wherein the inverter units are a first inverter unit and a second inverter unit; the control unit is configured to control the transistor switches of the first inverter unit when the optimal output efficiency of the integrated inverter apparatus is reached at an individual operation of the first inverter unit; the control unit is configured to control the transistor switches of the second inverter unit when the optimal output efficiency of the integrated inverter apparatus is reached at an individual operation of the second inverter unit.

13. The method of operating the integrated inverter apparatus of claim 11, in the step (c) wherein the inverter units comprise a first inverter unit and a second inverter unit; the control unit is configured to control the transistor switches of the first inverter unit and the second inverter unit when the optimal output efficiency of the integrated inverter apparatus is reached at an integral operation of the first inverter unit and the second inverter unit.

14. The method of operating the integrated inverter apparatus of claim 11, in the step (c) wherein the inverter units comprise a first inverter unit, a second inverter unit, and a third inverter unit; the control unit is configured to control the transistor switches of the first inverter unit and the second inverter unit when the optimal output efficiency of the integrated inverter apparatus is reached at a combinational operation of the first inverter unit and the second inverter unit; the control unit is configured to control the transistor switches of the second inverter unit and the third inverter unit when the optimal output efficiency of the integrated inverter apparatus is reached at a combinational operation of the second inverter unit and the third inverter unit; the control unit is configured to control the transistor switches of the first inverter unit and the third inverter unit when the optimal output efficiency of the integrated inverter apparatus is reached at a combinational operation of the first inverter unit and the third inverter unit.

15. The method of operating the integrated inverter apparatus of claim 11, in the step (b) wherein the output efficiency of the integrated inverter apparatus is obtained by calculating a ratio between an output power and an input power.

16. The method of operating the integrated inverter apparatus of claim 15, wherein the output power is calculated by a calculation unit according to an output current and an output voltage, and the output current is sensed by an output current-sensing unit and the output voltage is sensed by an output voltage-sensing unit; the input power is calculated by the calculation unit according to an input current and an input voltage, and the input current is sensed by an input current-sensing unit and the input voltage is sensed by an input voltage-sensing unit.

17. The method of operating the integrated inverter apparatus of claim 11, in the step (b) wherein the output efficiency of the integrated inverter apparatus is obtained by a lookup table.

18. The method of operating the integrated inverter apparatus of claim 12, wherein the lookup table is provided by storing the output efficiency of the integrated inverter apparatus in a storage unit.

19. The method of operating the integrated inverter apparatus of claim 13, wherein the field-effect transistor switches are junction field-effect transistor switches or metal-oxide-semiconductor field-effect transistor switches.

20. The method of operating the integrated inverter apparatus of claim 11, wherein each of the field-effect transistor switches has a fast recovery diode therein to reduce switching losses of the field-effect transistor switches.
